(19) United States
(12) Patent Application Publication
(10) Pub. No.: US 2015/0001943 A1
(43) Pub. Date: Jan. 1, 2015

(54) SYSTEM WITH DUAL BATTERY BACK-UP AND RELATED METHODS OF OPERATION

(71) Applicant: General Electric Company, Schenectady, NY (US)

(72) Inventors: Brandon Alan Bartling, Bethlehem, NY (US); Ayesha Maria Gonsalves, Schenectady, NY (US); Michael Alan Vallance, Albany, NY (US); Richard Louis Hart, Broadalbin, NY (US); David Charles Bogdan, JR., Charlton, NY (US)

(21) Appl. No.: 13/931,001

(22) Filed: Jun. 28, 2013

(51) Int. Cl. H02J 9/06

(52) U.S. Cl. CPC H02J 9/061
USPC 307/65

(57) ABSTRACT

A system includes a primary source of power, a main battery, a reserve battery, and a battery management system. A method for operating the system is also disclosed. The main battery of the system is electrically connected to the article, and the reserve battery is configured to back-up the main battery. The battery management system is electrically connected to the main battery. The battery management system maintains the reserve battery in a dormant state when the primary source of power is operational. The reserve battery is also maintained at a dormant state when the primary source of power is not operational; and the main battery is discharging and able to effectively back-up the primary source of power in supplying power to the article.

### BACKGROUND

The invention relates generally to a system having a main source of power and back-up (auxiliary) power arrangements. More particularly, some embodiments of the invention relate to systems including a primary power source; and a combination of a main battery and a reserve battery as a back-up for the primary power source.

Providing reliable and cost-effective power for wireless telecom applications is a challenge in many regions. Normally, a diesel generator provides power to the telecom tower for operation. Telecom operators face different challenges such as rising fuel costs, increasing emission pressures, space constraints, unreliable electric grids, and the high risk of theft of fuel and infrastructure. Many mobile and tower operators are turning to battery and hybrid solutions to improve the fuel efficiency of their diesel generators, and to act as a back-up power supply.

By using batteries in a continuous charge-discharge-cycling (CDC) operating mode, fuel costs and emissions can be substantially reduced, and overall system efficiency may be improved. The diesel engine that powers the generator works more efficiently when driving a larger electrical load, and the batteries provide that load. In such a strategy, the diesel-powered generator only operates during battery charging. The batteries power the tower electrical load during discharge. In the case of a break-down of the diesel-powered generator, the battery will discharge as normal, but will further discharge to keep the cell tower running beyond the normal operation (back-up time). This back-up time is provided by the battery so that a maintenance crew can arrive and repair/replace the generator.

Previously, some attempts to increase back-up time were carried out, but some challenges still remain. For example, at least one industry advocate has identified a need in the market for an enhanced back-up capability compared to the capability provided by lead-acid batteries. It was proposed that the typical telecom operators can oversize their VRLA (valve-regulated lead-acid) battery banks by as much as 300% to handle non-generator start events. However, oversizing results in greater long-term maintenance and higher initial costs, and hence makes a trade-off between lower system costs and total system reliability.

Therefore, there is a need for a comprehensive approach to meet the growing need for safer, durable, reliable and high performance energy storage solutions that are optimized for the higher back-up time. Embodiments of the present invention address these and other needs.

### BRIEF DESCRIPTION

In one embodiment, a system is presented. The system includes a primary source of power; a main battery; a reserve battery; and a battery management system. The primary source of power powers an article, and the main battery is electrically connected to the article. The reserve battery is configured to back-up the main battery. In some embodiments, the battery management system is electrically connected to both the main battery and the reserve battery. The battery management system is capable of maintaining the reserve battery in a dormant state when the primary source of power is operational. Further, the reserve battery is maintained in a dormant state when the primary source of power is not operational and the main battery is discharging, such that its state of charge is greater than a first threshold percentage value of its charge capacity in the fully charged state; and further, the main battery has a power delivery capability greater than a second threshold value based on an electrical demand of the article.

In one embodiment, a system is presented. The system includes a primary source of power; a main battery; a reserve battery; and a battery management system. The primary source of power powers an article, and the main battery is electrically connected to the article. The reserve battery is configured to back-up the main battery. The battery management system is electrically connected to the main battery. The battery management system is capable of maintaining the reserve battery in a dormant state when the primary source of power is operational. Further, the reserve battery is maintained in a dormant state when the primary source of power is not operational, and the main battery is discharging, such that its state of charge is greater than a first threshold percentage value of its charge capacity in the fully charged state; and further the main battery, has a power delivery capability greater than a second threshold value based on an electrical demand of the article.

In another embodiment, a method of powering an article is presented. The method includes a primary source of power providing power to the article, and a main battery providing power to the article when the primary source of power is not operational. The method further includes a reserve battery providing a back-up to the main battery. In the method, the reserve battery is activated when the primary source of power is not operating to power the article, and the main battery starts to discharge with either its state of charge equal to or less than a first threshold percentage value of its charge capacity in the fully charged state, or with its power delivery capability less than a second threshold value based on an electrical demand of the article.

### DRAWINGS

These and other features, aspects, and advantages of the present invention will become better understood when the following detailed description is read with reference to the accompanying drawings, in which like characters represent like parts throughout the drawings, wherein:

FIG. 1 is a schematic diagram of a system with dual back-up batteries, according to one embodiment of the invention; and

FIG. 2 is an exemplary schematic of a battery management system controlled reserve battery, according to one embodiment of the invention.

### DETAILED DESCRIPTION

Embodiments of the present invention describe a system including primary source of power; and a back-up system including a main battery and a reserve battery.

One or more specific embodiments of the present invention are described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

In the following specification and claims, the singular forms “a”, “an” and “the” include plural referents unless the context clearly dictates otherwise.

All ranges disclosed herein are inclusive of the endpoints, and the endpoints are combinable with each other. The terms “first,” “second,” and the like as used herein do not denote any order, quantity, or importance, but rather are used to distinguish one element from another.

Approximating language, as used herein throughout the specification and claims, may be applied to modify any quantitative representation that could permissibly vary, without resulting in a change in the basic function to which it is related. Accordingly, a value modified by a term such as “about” is not to be limited to the precise value specified. In some instances, the approximating language may correspond to the precision of an instrument for measuring the value.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances, an event or capacity can be expected, while in other circumstances, the event or capacity cannot occur. This distinction is captured by the terms “may” and “may be”.

A sodium metal halide battery or other type of battery, such as for example, a sodium-sulfur battery or other type of thermal battery, may be used as a back-up for the diesel generator or other main power source. (For simplicity, the sodium metal halide batteries will be exemplified). With their high charge acceptance and superior cycling performance, sodium metal halide batteries can act as the primary back-up energy source for telecom installations. As used herein, a “back-up energy source” is an energy source that can operate and power an article when a normally operated source of energy is not operational for a limited duration of time. The back-up energy source may power the article directly or through the normally operated source of energy. High-temperature batteries, such as sodium metal halide batteries, for example, are not affected by ambient temperature. Therefore telecom facility operators save money and space by removing unnecessary cooling/heating capability, making it an ideal solution for installations in extreme environments.

Very often, sodium metal halide batteries are used in applications wherein they cycle constantly, charging and discharging, as the primary power source starts and stops. These batteries exhibit heightened recharge acceptance when operated in a partial state of charge mode, which has the disadvantage of reduced residual capacity in the event of a malfunction of the primary power source.

Hence, in one case, telecom tower operators would like to have an extended amount of back-up time available in case the generator fails. In a second case, a battery having good cycle life and good recharge rate in standard operation is desirable, which can be realized by maintaining the battery at a lower capacity during the unused time.

Installing multiple batteries and/or oversized batteries may satisfy the cycling rate, cycle life, and back-up requirements of the application, but may increase the cost of installation and maintenance. Solutions that optimize the balance between high back-up time and good battery cycle rate and life would be welcome in the art.

Embodiments of the present invention provide a way to obtain higher back-up energy without foregoing the desirable cycle life of a sodium metal halide battery, and without adding higher cost. In one embodiment, a main battery is used as a back-up for the primary source of power. Further, a second energy storage system is used as a back-up for the main battery, to meet the requirements in case of a failure of the primary source of power and the main battery. In one embodiment, the main battery used herein is a rechargeable battery, and the second energy storage system used herein is a reserve battery.

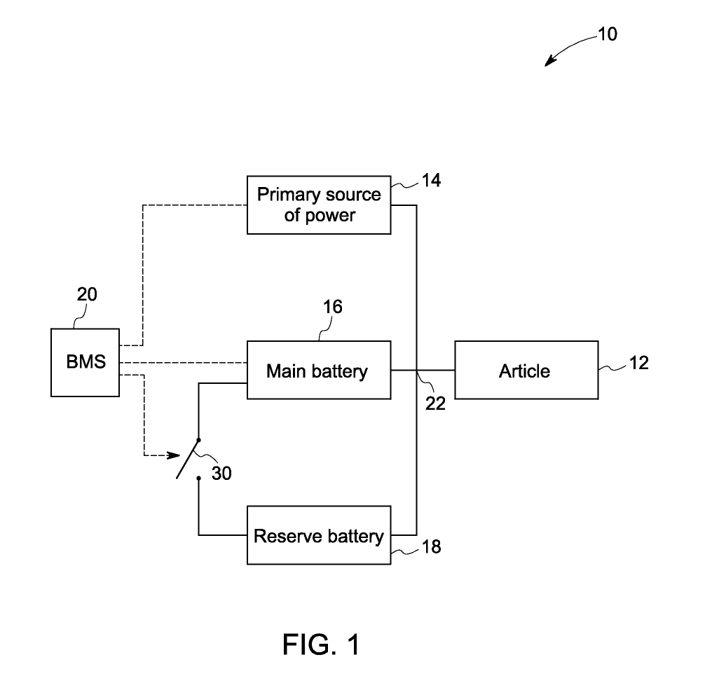

FIG. 1 illustrates a schematic of a system 10 including an article 12 that requires power. The article 12 may be a telecom tower. The primary source of power 14 powers the article 12. The primary source of power 14 may be a generator, a power grid, or an alternate source of power that primarily powers the article 12. The main battery 16 powers the article 12 when the primary source of power 14 is shut off, or when the power from the primary source of power 14 is not sufficient for running the article 12. The power from the main battery 16 may be supplied to the article 12 through the primary source of power 14; or directly, bypassing the primary source of power 14.

The article 12 may demand alternating current (AC) energy, direct current (DC) energy, or both. The primary source of power 14 may issue DC or AC energy. The batteries generally provide DC energy. In one embodiment, the energy from the primary source of power 14 is converted to DC energy using a rectifier.

In one embodiment, the primary power source 14 is a generator, and the main battery 16 is a rechargeable sodium metal halide battery (or other type of battery). The sodium metal halide battery normally includes an anode chamber; a cathode chamber that contains a mixture of cathodic material and electrolyte; and a separator. In the case of sodium metal halide batteries, the anode chamber may include a reduced source of sodium ions, such as, for example, molten sodium. The cathodic material may include sodium chloride and transition metals such as nickel, cobalt, and/or iron metals, along with their metal halides. The electrolyte may include an ionically conductive sodium metal halide, such as, for example, molten sodium aluminum tetrachloride NaAlCl₄. The anode chamber and cathode chamber are separated by a sodium ion-conducting, solid electrolyte separator.

When the sodium battery is charged by applying an over-potential between the cathode and the anode of the cell, sodium ions provided by the dissolution of sodium chloride from the cathode travel through the liquid electrolyte and the separator, and combine with electrons from the external circuit, to form the sodium electrode. The separator is electronically insulating, while at the same time, it is a conductor of sodium ions. When the cell is charged or partially charged, the anode contains liquid sodium. The chloride ions from the dissolution of sodium chloride react with the transition metal in the cathode to form metal chloride, and donate electrons back to the external circuit. The process is reversed during discharge, with sodium ions traveling through the separator to re-form NaCl in the cathode.

The system 10 further includes a reserve battery 18 and a battery management system (BMS) 20. In general, a reserve battery is designed in a reserve construction normally to withstand deterioration during storage, and to eliminate self-discharge prior to use. In a typical reserve battery, one of the key components of the cell is separated from the remainder of the cell until activation of the reserve battery. Hence, the reserve battery is usually stored in an inert state. In the inert state, a self-discharge by the chemical reaction between the cell components (such as for example, anode, electrolyte, and cathode) is prevented, and the battery is capable of long-term storage without any maintenance. Usually, the electrolyte of the cell, or a part of the electrolyte, is isolated to keep the battery in the inert state, when not in use. The activation of the reserve battery is accomplished by adding the missing component prior to use. A mechanical, thermal or electrical impulse trigger may activate the reserve battery rapidly.

Non-limiting examples of a reserve battery 18 include a water-activated battery; an electrolyte-activated battery; a gas-activated battery; and a heat-activated battery. The reserve battery 18 may be connected to the main battery 16, to the primary source of power 14, or to the article 12, or to any two of these components, or to all three of the components.

The battery management system (BMS) 20 is any electronic system that controls and protects the batteries, and relays information for monitoring the battery's condition. The BMS 20 may comprise the overall control system for the system 10, or it may comprise a sub-component, monitoring and controlling the power requirement for article 12. Batteries may be prevented from overcharging and deep discharging, and may be optimized for their high performance and life-time, by way of the BMS 20. The BMS 20 may monitor and control the main battery 16, and the reserve battery 18, and/or the primary source of power 14. In one embodiment, the BMS 20 is electrically connected to the main battery 16. In another embodiment, the BMS 20 is electrically connected to both the main battery 16; and the reserve battery 18, and controls their activity.

In one embodiment, the reserve battery 18 used herein is a limited-use reserve battery that is controlled via the BMS 20, and is only utilized when available energy and/or power in the main battery 16 is not on par with the power needs of the article 12. Hence, the reserve battery 18 can be used when both the primary source of power 14 and the main battery 16 together have nearly exhausted their energy in powering the article 12. Therefore, in some embodiments, the reserve battery 18 has very limited or no rechargeability, and experiences very low cycle count.

When the primary source of power 14 is operational and is satisfying the power requirements for article 12, there is no need for the main battery 16 or the reserve battery 18 to supply power to the article 12. Therefore, when the primary source of power 14 is operational, the main battery 16 will not usually be discharging to supply power to the article 12 or to the primary source of power 14. Further, the reserve battery 18 will usually be maintained in a dormant stage when the primary source of power 14 is active.

When the primary source of power 14 is not available, or is not able to provide enough power to the article 12, the main battery 16 starts providing the required power to the article. Thus, when the power need of the article 12 is not met by the primary source of power 14, the battery management system triggers the main battery to supply power to the primary source of power 14, or to the article 12 directly. The main battery 16 can supply the power requirement of the article for some time, depending on the charge capacity and power delivery capability of the main battery.

In the embodiment wherein the main battery 16 comprises a sodium metal halide cell, the amount of sodium chloride in the cathode defines the charge capacity of the cell. A lower sodium chloride loading in the cell is generally found to result in longer life of the sodium metal halide battery. Hence, if the main battery 16 cells contain high amounts of NaCl, the main battery 16 will be able to operate as a back-up of the primary source of power in powering the article 12 for an extended time. However, the lifetime of the main battery 16 may be reduced due to the high amounts of NaCl.

In one embodiment, in which a longer life is achieved for the main battery 16, the main battery is maintained in a partial state of charge, i.e., less than its full charge capacity. In one embodiment, a target state of charge of the main battery 16 at the end of the charge half cycle is less than about 80% of the charge capacity of the main battery 16 during a standard operation. In another embodiment, the main battery 16 is maintained at a charge capacity less than about 75% of the total possible charge capacity.

By using the main battery 16 in a partial state of charge (as compared to the charge state capable of providing the maximum back-up time), the cycle life of the main battery may be considerably increased. In one embodiment, a cycle life of the main battery 16 used in partial state of charge operation is greater than double the cycle life of the same battery used in a top-of-charge operation. In a specific embodiment, the cycle life of the main battery 16 used in partial state of charge operation is greater than triple the cycle life of the same battery used in top-of-charge operation.

In one embodiment, the main battery 16 and the reserve battery 18 are electrically connected. In one embodiment, the main battery 16 and the reserve battery 18 are electrically connected in an active state of the reserve battery 18. In one embodiment, the main battery is electrically connected to the reserve battery through the BMS 20. The BMS 20 may include a component, such as for example, a switch 30 that connects the reserve battery 18 to the main battery 16.

The reserve battery 18 is usually maintained in a dormant state even when the primary source of power 14 is not operational, but the main battery 16 is operational and able to power the article 12 as required. The reserve battery 18 is maintained in a dormant state when the main battery is charging. The reserve battery is also usually kept dormant when the main battery is discharging with sufficient energy to keep the article 12 operational. In one embodiment, the reserve battery 18 is kept in a dormant stage when the state of charge of the main battery 16 is greater than a first threshold percentage value of its charge capacity in the fully charged state and, additionally, the power delivery capability of the main battery 16 is greater than a second threshold value based on an electrical demand of the article 12. One skilled in the art would appreciate that all rechargeable batteries typically have calculated threshold values for their state of charge and power delivery capabilities that may vary, based on the components and construction of batteries, and based on the nature of the power demand dynamic of the powered article .

The first threshold value may vary depending on the application. In one embodiment, the first threshold value of the charge capacity of the main battery 16 for maintaining the reserve battery 18 in the dormant state is in a range from about 15% to about 25% of total charge capacity of the main battery 16. For example, in one embodiment, the reserve battery 18 is configured to be activated when the charge capacity of the main battery 16 diminishes to be below about 20% of the total charge capacity of the main battery in a standard operation.

The second threshold value for the power delivery capability of the main battery 16 may vary, depending on the electrical demand of the article. At a given time, the main battery 16 is delivering some level of power P to the article 12 at some voltage V, with a resistance of R_{cell}=(OCV−V)V/P, where the OCV is the open circuit voltage of the cell. A minimum voltage (Vₘᵢₙ) may be selected to protect the battery from over-discharge. Based on a desired maximum pulse power depending on an expected electrical load of the article, a maximum value of may be determined, such that the maximum pulse power may be uninterruptedly delivered to the article 12 from the main battery 16. The second threshold value for the power delivery capability of the main battery may be determined by planning the resistance R_{cell} to be in a certain range based on the electrical load of the article 12. The reserve battery 18 may be kept in a dormant stage until this designed R_{cell} value is maintained in the system 10.

A switch 30 or similar component may trigger the reserve battery 18 to become active when the charge capacity or the power delivery capability of the main battery diminishes to the level at which the main battery 16 is not able to sustain a continued back-up for the primary power source. The system 10 herein is designed such that, when the main battery 16 nearly exhausts its capacity to supply power to the article, the BMS 20 activates the reserve battery 18 to supply power. In one embodiment, the activation of the reserve battery 18 is executed by the main battery, by receiving a control signal from the BMS 20. The control signal may be any physical/thermal/chemical signal that is capable of initiating the activation of the reserve battery for use.

The reserve battery 18 used herein may be operable in the active state at the normal operating temperature of the article, primary source of power, and the main battery 16. In one embodiment, the reserve battery 18 is operable over a temperature range from about −10° C. to about 60° C. In one embodiment, the reserve battery 18 used herein is an electrolyte-activated battery having positive and negative electrodes comprising solid species, and an electrolyte comprising a liquid species. The electrolyte in the active state of the reserve battery 18 may include dissolved solid species of at least a part of the electrodes of the dormant state of the reserve battery 18. For example, a magnesium/cuprous chloride reserve battery might include copper (I) chloride and magnesium chloride in the electrolyte.

The reserve battery 18 can be maintained in a dormant state by keeping apart the electrolyte and electrodes, so that the electrolyte is not in electrical communication with the electrodes. This separation may be achieved by different means, including a mechanical separation such as, for example, a valve that controls the contact of electrolyte and electrodes, keeping them separate in the dormant state of the reserve battery 18. The reserve battery can then be activated by contacting the electrolyte with the electrodes by opening the valve when needed. In one example, the reserve battery 18 may comprise magnesium as a part of the negative electrode, and the electrolyte of the reserve battery may include water. In this instance, the reserve battery 18 is activated by controlling the water contact with the electrodes.

The activation of the reserve battery 18 may require a control signal and some energy of activation. The control signal may be an indicator for the reserve battery 18 to start working, and the energy of activation may be the energy required to bring the dormant reserve battery 18 into the active state. The energy of activation may be used to bring the electrolyte and electrodes in contact with each other, so that the reserve battery begins working. In one embodiment, this energy of activation is supplied from the main battery 16, before the main battery 16 runs out of its energy completely.

The BMS 20 may monitor the charge state of the main battery 16; the required charge for the main battery 16 to power the article 12; and the required charge for the main battery 16 to activate the reserve battery 18. In this manner, the control signal is transmitted to provide the connection to reserve battery 18—often close to the time when the main battery's back-up energy is exhausted, and can no longer power the article 12. Alternately, there may be a mechanism in the reserve battery 18 that would trigger the electrical communication between the electrolyte and electrodes in the reserve battery 18, e.g., by receiving a control signal from the BMS 20. In a specific embodiment, the electrical communication between the electrolyte and electrodes in the reserve battery 18 is controlled by a valve or a seal.

The maintenance cost of the reserve battery 18 used herein is usually much lower than the cost for any other type of back-up battery. The reserve battery 18 is not cycled during normal operation, and used only when the main battery 16 back-up is not sufficient to run the article 12. When a failure of the primary source of power 14 occurs, and the energy back-up provided by the main battery 16 is about to terminate, the BMS 20 sends a signal to the main battery 16 or the reserve battery 18 to activate the reserve battery 18 for use, until repair (or replacement) of the primary source of power 14 can be undertaken. Following repair of the primary source of power 14, the reserve battery 18 may be recharged via a variety of methods, or may be easily replaced, due to its relatively low cost, and maintained in the dormant state until a next failure occurs.

In one embodiment, the system 10 is designed such that all three power sources (primary source of power 14, main battery 16, and the reserve battery 18) supply DC energy at the same potential to the article 12. A slightly higher voltage may be drawn from the primary source of power to charge the main battery during operation. The three power sources may connect at a DC bus 22. There may be some DC-AC inverters and DC-DC converters between the DC bus 22 and the article 12, as may be required (not shown). Further, there may be DC-DC converters between the DC bus 22 and the batteries 14, 16, and 18, if the bus voltage is not well matched to the batteries so as to meet the power requirement of the article 12.

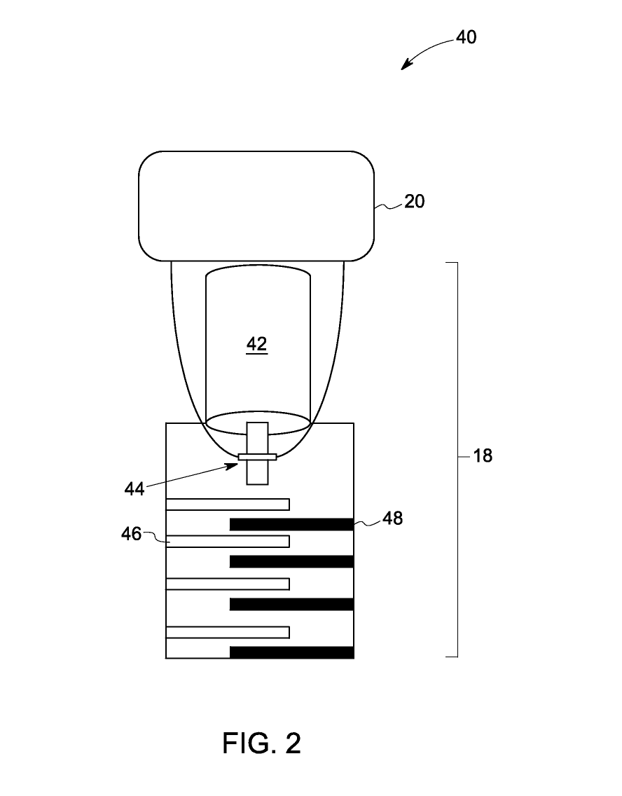

FIG. 2 illustrates a schematic of a proposed exemplary system 40, having a reserve battery 18. In the proposed system 40, the electrolyte stored in the above reservoir 42 may be as innocuous as salt water (for an Al system), or dilute ammonium chloride (for a Zn/MnO₂ system). When an event has been sensed by the BMS 20, a signal is sent to an event-driven valve 44. A simple concept for this value would be a high temperature wax plug that melts via an embedded resistor element. Once triggered, the electrolyte is dispensed into the dry stored electrode plates: anode 46 and cathode 48, for cell activation. The number of these inserted plates may be varied depending on the amount of back-up time requested.

After use, a field technician could arrive on-site in one illustrative scenario, with a fresh container of electrolyte, and new electrode plates. To regenerate the system, the technician may drain the electrolyte from the bottom part of the battery through a drain plug (not shown), remove the spent electrodes and insert new electrodes. A new trigger valve may be inserted, and the electrolyte tank is refilled. The system 40 is now available for use again.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system comprising:
a primary source of power to an article;
a main battery electrically connected to the article;
a reserve battery configured to back-up the main battery; and
a battery management system electrically connected to the main battery and the reserve battery, and capable of maintaining the reserve battery in a dormant state, when
(a) the primary source of power is operational, or
(b) the primary source of power is not operational and the main battery is discharging with
(i) its state of charge greater than a first threshold percentage value of its charge capacity in the fully charged state; and
(ii) its power delivery capability greater than a second threshold value based on an electrical demand of the article.

2. The system of claim 1, wherein the main battery is a rechargeable battery.

3. The system of claim 1, wherein the main battery and the reserve battery are in a parallel electrical arrangement with the primary source of power.

4. The system of claim 1, wherein the main battery and the reserve battery are electrically connected in an active state of the reserve battery.

5. The system of claim 4, wherein the main battery is electrically connected with the reserve battery through the battery management system.

6. The system of claim 4, wherein the reserve battery in the active state is operable over a temperature range from about −10° C. to about 60° C.

7. The system of claim 4, wherein the reserve battery comprises positive and negative electrodes, each comprising a solid species; and an electrolyte comprising a liquid species.

8. The system of claim 7, wherein an electrical communication between the electrolyte and the electrodes is controlled by a valve or a seal.

9. The system of claim 7, wherein the electrolyte is not in electrical communication with the electrodes in the dormant state of the reserve battery.

10. The system of claim 7, wherein the electrolyte is in electrical communication with the electrodes in the active state of the reserve battery.

11. The system of claim 7, wherein the electrolyte in the active state of the reserve battery comprises dissolved solid species from at least a portion of the electrodes of the dormant state of the reserve battery.

12. The system of claim 7, wherein a negative electrode of the reserve battery comprises magnesium.

13. The system of claim 7, wherein the electrolyte of the reserve battery comprises water.

14. The system of claim 1, wherein the main battery comprises a sodium metal halide battery.

15. The system of claim 14, wherein the sodium metal halide battery is characterized by a cycle life greater than about 4000 cycles; and a provisional capacity for back-up time less than about 2 hours following a failure of the primary source of power to restart.

16. The system of claim 1, wherein the threshold percentage value of residual charge capacity is in a range from about 15% to about 25%.

17. A system comprising:
a primary source of power to an article;
a main battery electrically connected to the article;
a reserve battery configured to back-up the main battery; and
a battery management system electrically connected to the main battery and capable of maintaining the reserve battery in a dormant state, when
(b) the primary source of power is operational, or
(b) the primary source of power is not operational and the main battery is discharging with
(i) its state of charge greater than a first threshold percentage value of its charge capacity in the fully charged state; and
(ii) its power delivery capability greater than a second threshold value based on an electrical demand of the article.

18. A method of powering an article, comprising:
providing power to the article with a primary source of power;
providing power to the article with a main battery when the primary source of power is not operational; and
providing a back-up to the main battery with a reserve battery, wherein the reserve battery is activated when
(a) the primary source of power is not operating to power the article; and
(b) the main battery starts to discharge with
(i) its state of charge equal to or less than a first threshold percentage value of its charge capacity in the fully charged state; or
(ii) its power delivery capability is less than a second threshold value based on an electrical demand of the article.

19. The method of claim 18, wherein the reserve battery is activated by supplying energy from the main battery.

20. The method of claim 19, wherein the reserve battery is activated by a battery management system by connecting the main battery and the reserve battery.

21. The method of claim 19, wherein the reserve battery comprises positive and negative electrodes and an electrolyte, and the reserve battery is activated by establishing an electrical communication between the electrolyte and the electrodes.

22. The method of claim 21, wherein the electrical communication between the electrolyte and the electrodes is established by activating a valve.
